(19) United States
(12) Patent Application Publication
(10) Pub. No.: US 2026/0274140 A1
(43) Pub. Date: Sep. 17, 2026

(54) VEHICULAR TAILGATE HAVING INDUCTION COOKTOP UNIT

(71) Applicant: David Ware, Lincoln, NE (US)

(72) Inventor: David Ware, Lincoln, NE (US)

(21) Appl. No.: 19/459,261

(22) Filed: Jan. 26, 2026

Related U.S. Application Data
(60) Provisional application No. 63/769,842, filed on Mar. 11, 2025.

(51) Int. Cl. B60N 3/16; B62D 33/03

(52) U.S. Cl. CPC B60N 3/16; B62D 33/03

(57) ABSTRACT

A vehicular system, having a tailgate configured to be installed on a rear of a vehicle, the tailgate configured to rotate from a closed position at least to a deployed position. The tailgate includes a rear tailgate panel, a lid assembly, and a food preparation unit positioned in a cavity of the tailgate. The food preparation unit is electrically coupled to the electrical system of the vehicle, powering one or more food preparation elements, including induction cooking zones, blender ports, or telescopic smokers.

### CROSS-REFERENCE TO RELATED APPLICATIONS

The present application claims the benefit under 35 U.S.C. § 119(e) of U.S. Provisional App. No. 63/769,842, filed Mar. 11, 2025, which is incorporated herein by reference.

### BACKGROUND

Tailgating is a popular social activity that can involve large amounts of time and effort to execute. For example, tailgating can involve participants preparing food in advance, keeping it warm while in transit and for the duration of the activity, and/or loading, transporting, and using cooking appliances. Often, such appliances might not be intended for transport or may be intended for small camping applications. Accordingly, the use of such appliances for tailgating may make tailgating inconvenient and involve significant time and effort.

### SUMMARY

In some aspects, the techniques described herein relate to a vehicular system, including: a tailgate configured to be installed on a rear of a vehicle, the tailgate configured to rotate from a closed position at least to a deployed position, the tailgate including: a rear tailgate panel located at the rear of the vehicle when the tailgate is in the closed position and at the bottom of the tailgate when the tailgate is in the deployed position; a lid assembly including a lid and at least one hinge, wherein the lid is rotatably connected to the tailgate via the at least one hinge such that the lid is configured to rotate between a lid open position and a lid closed position, wherein the lid is located at the front of the tailgate when the tailgate is in a closed position and at the top of the tailgate when the tailgate is in a deployed position, wherein each of the at least one hinge is located at the front and bottom of the tailgate when the tailgate is in the closed position and at the front and the top of the tailgate when the tailgate is in the deployed position; and a food preparation unit positioned in a cavity of the tailgate and positioned between the rear tailgate panel and the lid when the lid is in the lid closed position, wherein the food preparation unit includes: an induction cooktop unit having at least one induction cooking zone.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1A shows an environmental view of a vehicle tailgate in a closed configuration according to an exemplary embodiment;

FIG. 1B shows an environmental view of a vehicle tailgate in a deployed configuration with an closed lid assembly according to an exemplary embodiment;

FIG. 1C shows an environmental view of a vehicle tailgate in a deployed configuration with an open lid assembly according to an exemplary embodiment;

FIG. 2 shows an environmental view of a vehicle tailgate and cooking zones according to an exemplary embodiment;

FIG. 3 shows a top view of a food preparation unit according to an exemplary embodiment;

FIG. 4A shows a partial, top view of a cooktop unit and griddle plate according to an exemplary embodiment;

FIG. 4B shows a partial, side view of a cooktop unit and griddle plate according to an exemplary embodiment;

FIG. 5A shows an environmental view of a vehicle tailgate and collapsible silicone lid according to an exemplary embodiment;

FIG. 5B shows an environmental view of a vehicle tailgate, collapsible silicone lid, and cooking zones according to an exemplary embodiment; and

FIG. 6 shows a block diagram of a control system suitable for implementing an exemplary embodiment.

### DETAILED DESCRIPTION

Before explaining various embodiments of the inventive concepts disclosed herein in detail, it is to be understood that the inventive concepts are not limited in their application to the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of a feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in at least one embodiment” in the specification does not necessarily refer to the same embodiment. Embodiments of the inventive concepts disclosed may include one or more of the features expressly described or inherently present herein, or any combination or sub-combination of two or more such features.

Broadly, embodiments of the inventive concepts disclosed herein are directed to a vehicular system including a tailgate of a vehicle having a food preparation unit positioned in a cavity of the tailgate. The food preparation unit, for example, may include induction cooking zones (e.g., integrated induction cooking zones), a smoker box, an electric blender motor, and/or other features. In some embodiments, the food preparation unit may be connected to the electrical system of the vehicle. For example, the food preparation unit may include at least one processor and/or at least one power switch (e.g., at least one selective power switch and/or at least one master power switch) to control power to the cooking zones. Furthermore, the layout of the food preparation unit may be customizable, allowing cooking zones and other elements to be removable and/or swapable. The vehicle tailgate may include recesses (e.g., cavities) for receiving corresponding cooking zones. In some embodiments, the tailgate may include a smoker box. For example, the smoker box may be collapsible and may include a smoker heating element configured to heat wood pellets so as to cause the pellets to generate smoke. The tailgate may include a lid (e.g., a collapsible silicone lid which may include a fan) to cover the cooking zones when not in use and/or when the tailgate is closed. In some embodiments, a griddle plate may be placed over one or more of the cooking zones. In some embodiments, the griddle plate may be sloped to direct drippings into a drip pan, and the drip pan can be a separate device or integrated into the griddle plate. The griddle plate may include raised ridges to guide drippings and/or to impart grill marks. In some embodiments, the cooking zones may be integrated into a single induction cooktop unit. For example, the induction cooktop unit may include one or more power distribution elements and/or one or more processors. For example, the power distribution elements may separately and/or collectively power the cooking zones and/or may be electrically connected to the electrical system of the vehicle. In some embodiments, the induction cooktop unit, the griddle plate, the cutting board, and the blender port, as well as any other elements integrated into the tailgate, may all fit within a standard tailgate thickness, which can often be 5.5 inches.

Some embodiments may include a convenient system for tailgating activities that does not otherwise compromise the functionality of a vehicle. It would also be advantageous to have better cooking facilities than are usually available while tailgating

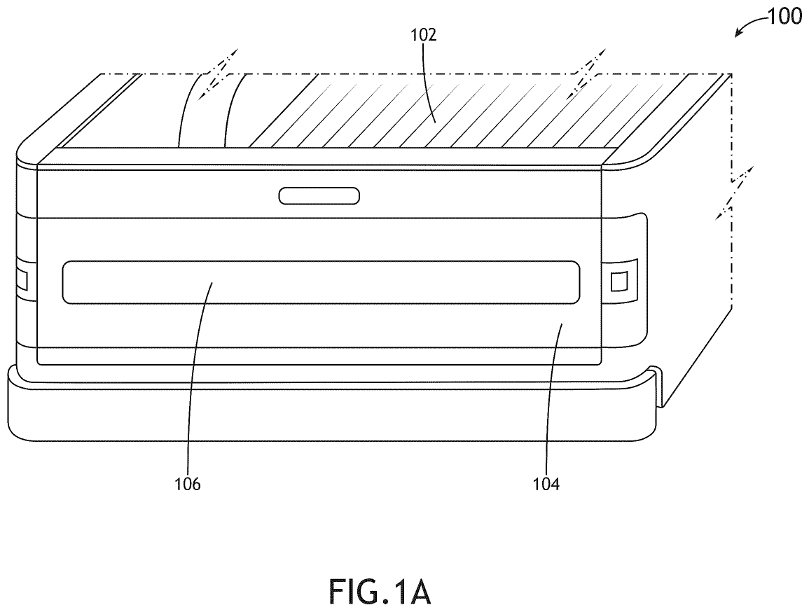

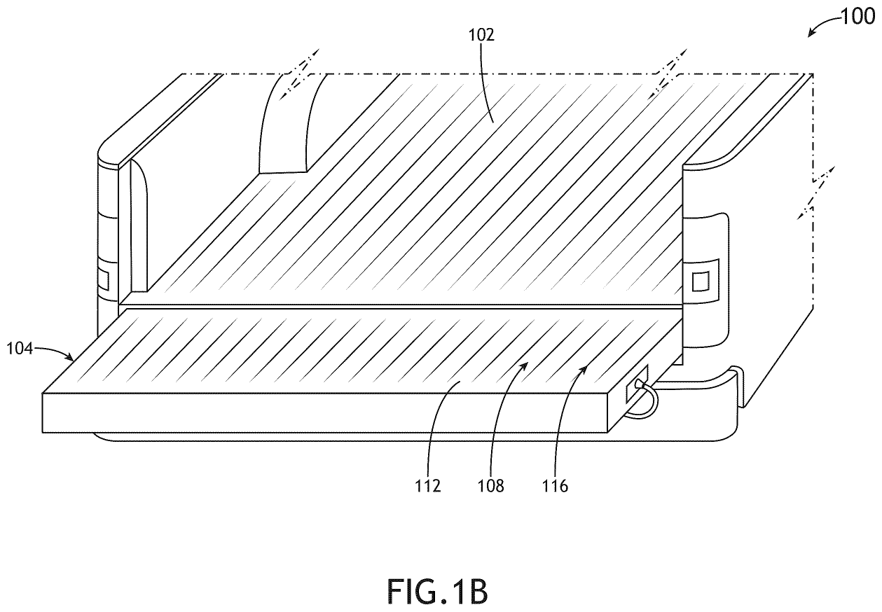

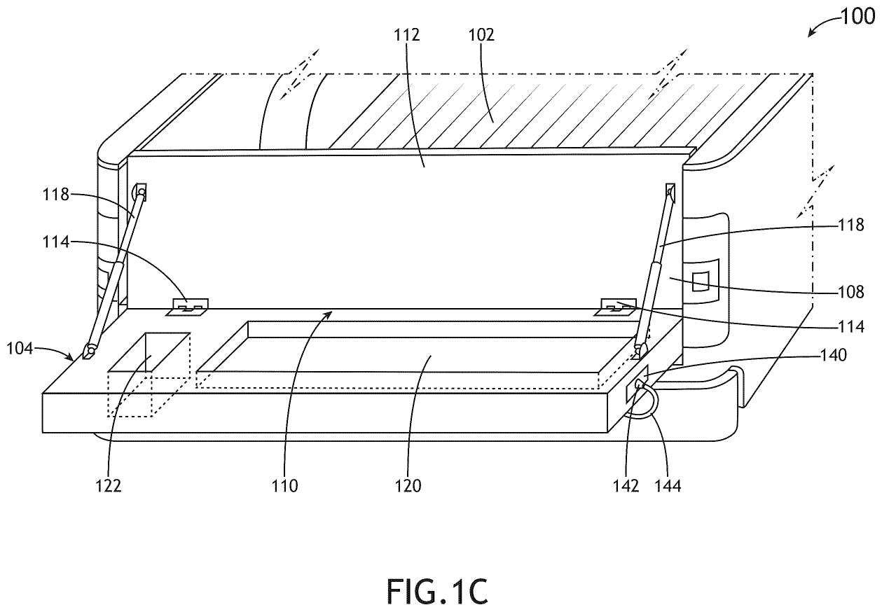

Referring to FIGS. 1A-1C, an environmental view of a vehicle 100 comprising a truck bed 102 and a tailgate 104 according to an exemplary embodiment is shown. Broadly, the tailgate 104 may be configured to be installed on a rear of the vehicle 100 and may be further configured to rotate from a closed position to a deployed position. For example, the tailgate 104 may be installed and/or incorporated into any suitable vehicle 100, such as a pick-up truck, a sport utility vehicles (SUV), an all-terrain vehicle (ATV), a utility terrain vehicle (UTV), or a golf cart. In some embodiments, the tailgate 104 may include a rear tailgate panel 106, a lid assembly 108, and/or a food preparation unit 110.

In some embodiments, the rear tailgate panel 106 may be located at the rear of the vehicle 100 when the tailgate 104 is in the closed position (as depicted in FIG. 1A) and at the bottom of the tailgate 104 when the tailgate 104 is in the deployed position (as depicted in FIG. 1B).

As further exemplarily depicted, the lid assembly 108 of the tailgate 104 may include a lid 112 and at least one hinge 114. The lid 112 may be and/or include a cover or a top portion of the lid assembly, which, when closed, may protect the interior parts and/or components of the lid assembly 108 and/or the food preparation unit 110. For example, the lid 112 may be rotatably connected to the tailgate 104, via the at least one hinge 114, such that the lid 112 may be configured to rotate between a lid open position (depicted in FIG. 1C) and a lid closed position (depicted in FIG. 1B). In some embodiments, the lid 112 may be located at the front of the tailgate 104 when the tailgate 104 is in the closed position and the lid 112 may be further located at the top of the tailgate 104 when the tailgate 104 is in the deployed position. Furthermore, as depicted in FIG. 1B, a portion of the lid 112 may be and/or may include a liner material (e.g., a bed liner material 116). For example, the bed liner material 116 may be suitable for use in the bed of a pickup truck, and the bed liner material 116 may be composed, at least in part, of at least one synthetic polymer (e.g., at least one plastic material). In some embodiments, the bed liner material 116 may protect the tailgate 104 from objects stored in the bed of vehicle 100. The bed liner material 116 may be located at a front exterior of the tailgate 104 when the tailgate 104 is in the closed position and the bed liner material 116 may be further located at a top exterior of the tailgate 104 when the tailgate 104 is in the deployed position.

As exemplarily depicted, the lid 112 may be rotatably connected to the tailgate 104 via two hinges 114, including in the exemplary embodiment depicted in the figures. Furthermore, each of the at least one hinge 114 may be located at the front and bottom of the tailgate 104 when the tailgate is in the closed position. The at least one hinge 114 may be located at the front and the top of the tailgate 104 when the tailgate 104 is in the deployed position.

In some embodiments, the lid assembly 108 may include one or more support rods 118 that may be utilized in maintaining the lid 112 in the open position. For example, the one or more support rods 118 may be collapsible cylinders (e.g., collapsible pneumatic or hydraulic cylinders) or struts (e.g., collapsible gas struts). For example, as depicted, the lid assembly 108 may include two support rods 118, which may be positioned along opposite sides of the tailgate 104. In some embodiments, the one or more support rods 118 may be at least one gas strut configured to extend between the tailgate 104 and the lid 112 when the lid 112 is in the lid open position. For example, the at least one gas strut may be configured to support the lid 112 when the lid 112 is in the lid open position such that, when a user opens the lid 112, the one or more support rods 118 maintain the lid in the open or deployed position.

In some embodiments, the food preparation unit 110 may be and/or may be installed within a portion or section of the tailgate 104, which may be configured as an area for use by an end user in the preparation of food. As described herein, the food preparation unit 110 may be utilized by the end user for preparing food (e.g., cutting food on a cutting board or organizing food on dishes or trays, for cooking food (e.g., heating food on induction cooktop and/or smoking food in a smoker, for blending food (e.g., blending food in a blender)).

As exemplarily depicted, the food preparation unit 110 may be positioned within at least one cavity of the tailgate 104 and/or may be positioned between the rear tailgate panel 106 and the lid 112 when the lid 112 is in the closed position. In some embodiments, the food preparation unit 110 may include one or more recesses (e.g., cavities) that may be configured to house one or more sub-components of the food preparation unit 110. For example, the food preparation unit 110 may have at least one cavity (e.g., a first cavity 120 and/or a second cavity 122).

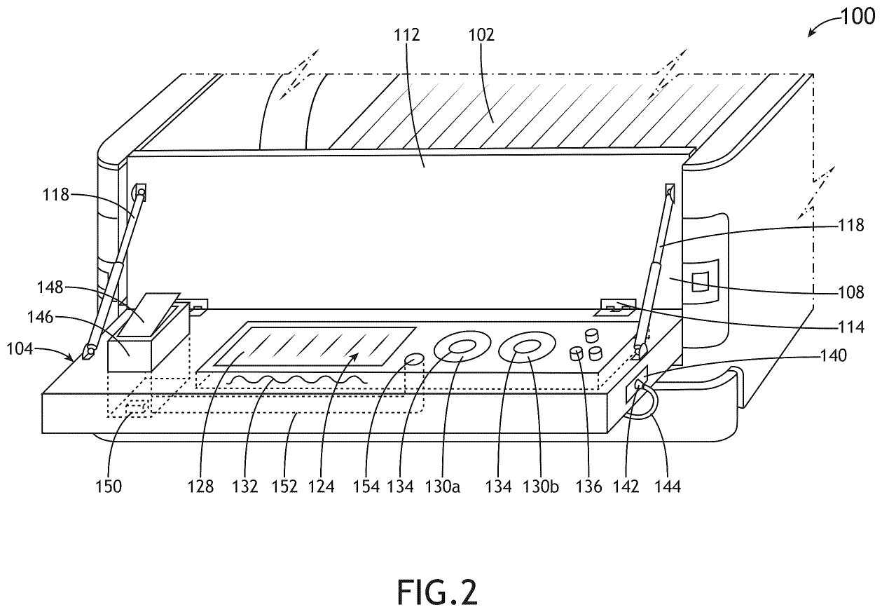

Referring now to FIG. 2, an environmental view of the vehicle tailgate 104 according to an exemplary embodiment is depicted. The food preparation unit 110 of the tailgate 104 may include an induction cooktop unit 124 having at least one induction cooking zone (e.g., at least one independently powered cooking zone 128 and/or at least one shared-power cooking zone 130a, 130b).

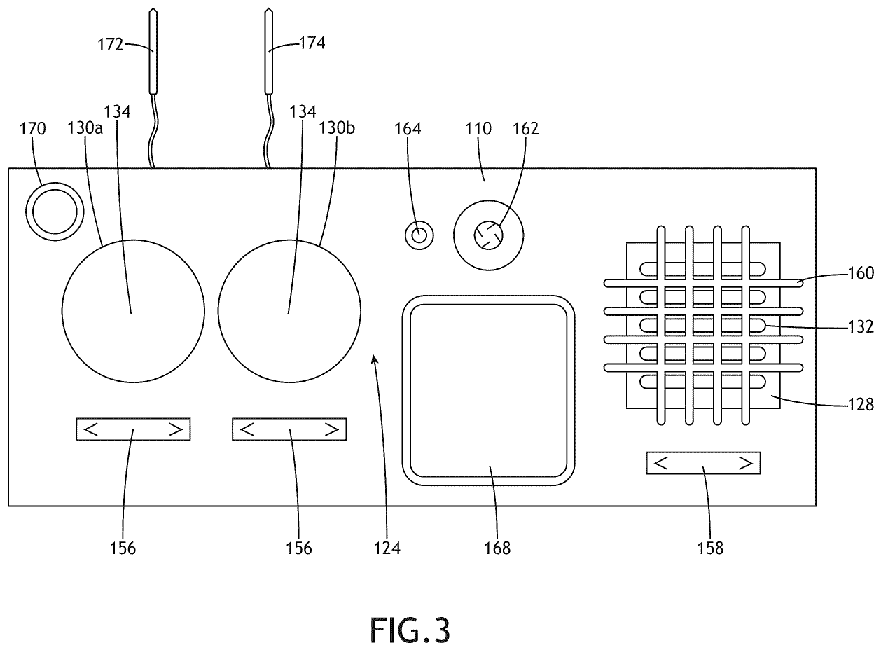

For example, each of the at least one induction cooking zone may have at least one induction element (e.g., at least one independently powered induction element 132 and/or one or more shared-power induction elements 134 as shown in FIG. 3)) of the induction cooktop unit 124. For example, each induction element may be configured to induce an inductive current in induction-compatible cookware (e.g., induction-compatible griddles, pots, and/or pans) positioned in a particular cooking zone so as to cause the induction-compatible cookware to heat up. In some embodiments, the induction cooktop unit 124 may include at least one induction cooking zone, which may be configured to cause the heating and cooking of food items.

As exemplarily depicted in FIG. 2, the induction cooktop unit 124 may include an independently powered cooking zone 128 and two shared-power cooking zones 130a, 130b. For example, the independently powered cooking zone 128 may include at least one independently powered induction element 132 as shown in FIG. 2. For example, the independently powered cooking zone 128 may include one or more independently powered induction elements 132 that may improve uniformity of heating throughout the surface of the independently powered cooking zone 128. The one or more independently powered induction elements 132 may be electrically activated and cause generation of heat.

In some embodiments, the independently powered cooking zone 128 can be configured to operate in multiple power states (e.g., a normal power state or a boosted power state). For example, while operating in the boosted powered state, the independently powered cooking zone 128 (e.g., the independently powered induction element 132 of the independently powered cooking zone 128) may receive more power than in the normal power state. For example, the increase in power while operating in the boosted powered state may be applied to one or more independently powered induction elements 132, thereby, increasing the speed at which the independently powered cooking zone 128 causes inductive heating and/or increasing the maximum temperature that the independently powered cooking zone 128 can cause to be achieved as compared against operation in the normal power state. For example, the boost to the power supplied to the independently powered cooking zone 128 may be increased, such as by a factor of two, which can result in water reaching a boiling point faster as compared to operation in the normal power state.

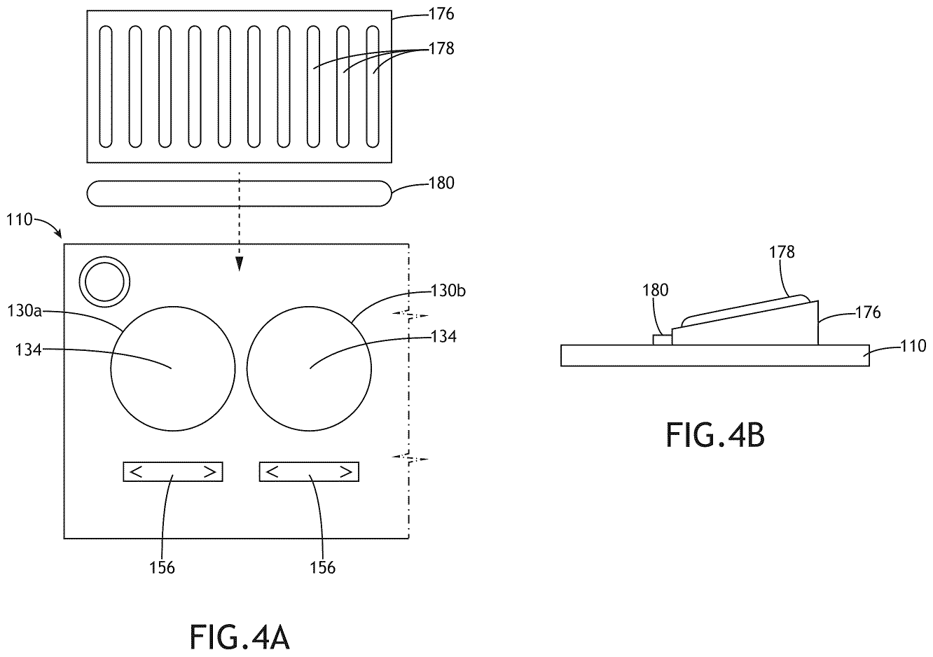

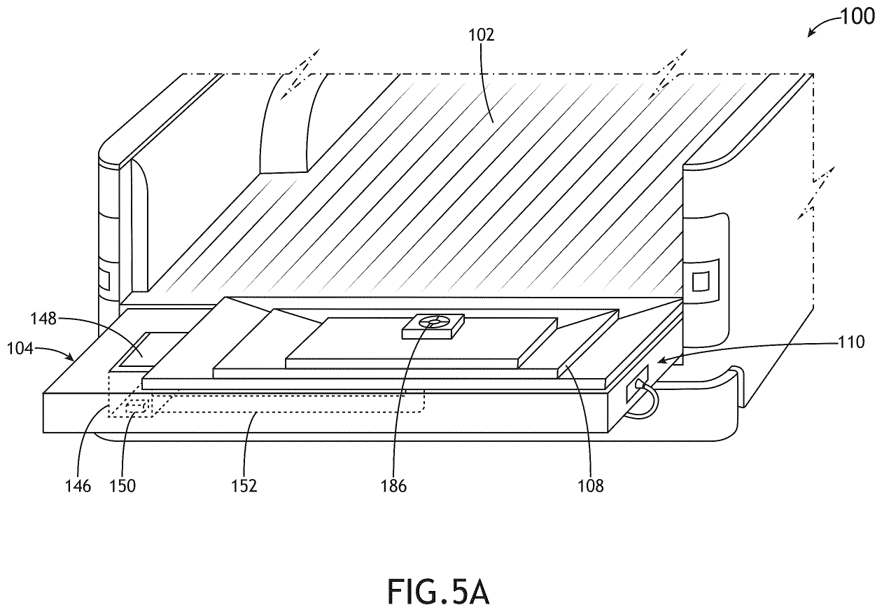

In some embodiments, the two shared-power cooking zones 130a, 130b may be two induction cooking zones and may be positioned adjacent to one another on the surface of the induction cooktop unit 124. In some embodiments, the two shared-power cooking zones 130a, 130b may be bridgeable to evenly distribute available power among the two shared-power cooking zones such that the two shared-power cooking zones operate (e.g., effectively operate) as a single induction cooking zone, which is larger than each of two shared-power cooking zones 130a, 130b. In some embodiments, the two shared-power cooking zones 130a, 130b may be configured for use with accessories to provide different cooking features. In some embodiments, the induction cooktop unit 124 may include a removable griddle plate (as depicted in FIG. 4A-4B and described in greater detail below). The two shared-power cooking zones 130a, 130b may be heated via one or more shared-power induction elements 134. In some embodiments, the one or more shared-power induction elements 134 may be used to inductively heat the two shared-power cooking zones 130a, 130b simultaneously. In some embodiments, each of the one or more shared power induction elements 134 may be positioned relative to (e.g., within or under) a respective zone of the two shared-power cooking zones 130a, 130b.

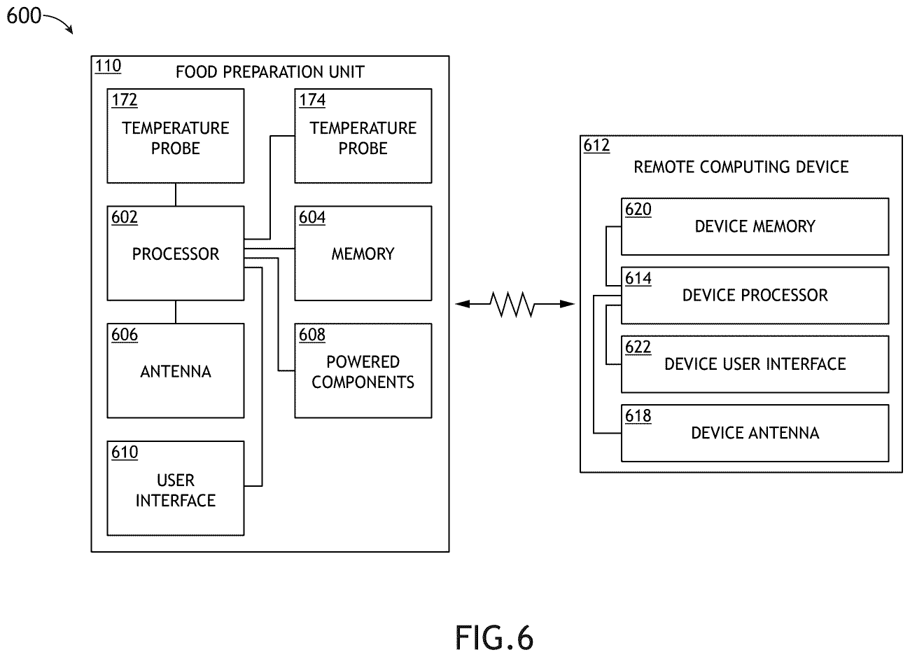

In some embodiments, the food preparation unit 110 may include a user-interface (e.g., 610, as shown in FIG. 6), which may include controls (e.g., at least one food preparation unit control 136 and/or at least one control 156). In some embodiments, the food preparation unit controls 136 may be interfaced by a user to control one or more aspects of the food preparation unit 110, for example, to activate and/or increase the temperature of the induction cooktop unit 124. For example, the food preparation unit controls 136 may include physical controls (e.g., any combination of buttons, slides, knobs, or other physically actuatable or interactive controls) and/or other controls (e.g., graphical user interface (GUI) controls). In some embodiments, the food preparation unit 110 may optionally and/or additionally utilize electronic controls, such a touch screen located on the food preparation unit 110 or via a remote computing device 612 (e.g., smartphone, tablet, or other piece of external computing hardware). In some embodiments, a single food preparation unit control 136 may be configured to control a plurality of components or features of the food preparation unit 110, such as for example, controlling the independently powered cooking zone 128 and the two shared-power cooking zones 130a, 130b. In some embodiments, multiple food preparation unit controls 136 may be utilized for selective control of particular components or sections of the food preparation unit 110. For example, and as described below, the independently powered cooking zone 128 may have its own controls and the two shared-power cooking zones 130a, 130b may have its own, separate controls.

In some embodiments, tailgate 104, and by extension the induction cooking zone, food preparation unit 110, and/or other components of the tailgate 104 may be electrically coupled to at least one power source (e.g., such as a vehicle battery or generator) through an electrical connection. For example, and as depicted in and described with respect to at least some of the exemplary embodiments associated with FIGS. 1A-C, the power source may be electrically connectable to the food preparation unit 110 and/or the tailgate 104 via at least one power cord 144, at least one electrical adaptor port (e.g., located on the food preparation unit 110 and/or the tailgate 104), and/or at least one magnet 142 such that an electrical connection may be formed from the power source to the food preparation unit 110 and/or the tailgate 104. After receiving electricity from the power source, a processor (e.g., processor 602 as described in reference to FIG. 6) can selectively cause one or more components of the tailgate 104 to be powered and/or activated. In some embodiments, the electrical connection includes an electrical adaptor port 140 located on a portion of the food preparation unit 110. The electrical adaptor port 140 may further include at least one magnet 142, and the electrical adaptor port 140 may be configured to magnetically engage with a power cord 144. The power cord 144 may be electrically coupled to the power source and used to provide power to the tailgate 104 and/or the food preparation unit 110. Accordingly, the powered elements of the food preparation unit 110 are electronically coupled to the electrical adaptor port 140, such that electricity can be provided to each powered element. For example, wiring or electrical connections between the induction cooking zone and the electrical adaptor port 140 provides for the powering on and use of the induction cooking zone (e.g., independently powered cooking zone 128 and/or two shared power cooking zones 130a, 130b).

In some embodiments, the food preparation unit 110 may comprise additional and/or optional features, such as smoker boxes 146, blenders, blender ports (e.g., 162, as shown in FIG. 3), cutting boards (e.g., 168, as shown in FIG. 3), etc. For example, in the exemplary embodiment depicted in FIG. 2, the food preparation unit 110 comprises a telescoping smoker box 146. Furthermore, the telescoping smoker box 146 may be at least partially stowed or housed within a second cavity 122. From its stowed position in the second cavity 122, the telescoping smoker box 146 may be configured to be telescopically expanded vertically in height from a smoker box stowed position to a smoker box extended position. When utilizing the food preparation unit 110, it may be desirable to apply smoke to the food being cooked. In such embodiments, the telescoping smoker box 146 may be filled with pellets via a smoker box lid 148 and may include internal structures such that meats may be deposited for smoking. Furthermore, the telescoping smoker box 146 may be configured to hold wood pellets that may be heated via a smoker heating element 150 to produce smoke. The resulting smoke may infuse food within the smoker box 146. In some embodiments, the telescoping smoker box 146 may have smoke outlet tubing 152 to the induction cooktop unit 124 (and/or other portions of the food preparation unit 110), whereby smoke from the smoker box 146 may be transferred to infuse food at the induction cooktop unit 124 (and/or other portions of the food preparation unit 110). For example, the transported smoke may be directed to the surface of the food preparation unit 110 via one or more smoke outlets 154 or other openings at a terminal end of the smoke outlet tubing 152.

In at least one embodiment, the telescoping smoker box 146 comprises a telescoping body, allowing the telescoping smoker box 146 to be collapsed into the second cavity 122 in the food preparation unit 110 when the tailgate 104 is closed or when the telescopic smoker box 146 is not otherwise in use. For example, the smoker box 146 may expand from two inches to eight inches in height.

Referring now to FIG. 3, a top view of an exemplary food preparation unit 110 according to an exemplary embodiment is shown. The exemplary embodiment of the food preparation unit 110, as depicted in FIG. 3, shows a possible layout and configuration of various components of the food preparation unit 110. However, it should be understood that the embodiment depicted in FIG. 3 is for illustrative purposes only, and that the configuration and layout of the food preparation unit 110 may vary. For example, as depicted, the exemplary food preparation unit 110 includes two shared power cooking zones 130a, 130b and at least one shared-zone cooking control 156; the exemplary food preparation unit 110 includes an independent powered cooking zone 128 and at least one independent-zone cooking control 158.

As described above, the food preparation unit 110 may include various different zones dedicated or otherwise used for various food preparation activities, including cooking food, blending food, or cutting food. FIG. 3 depicts various examples of such additional and/or optional zones.

In some embodiments, the food preparation unit 110 may comprise one or more additional and/or optional features or components, including for example, a removable roaster rack 160. In some embodiments, the removable roaster rack 160 may be a selectively positionable and removable rack (e.g., grate, wire, or mesh) for the placement of food items. In some embodiments, the removable roaster rack 160 may be removably positioned on the food preparation unit 110 approximate to the independently powered cooking zone 128, for example. In such a configuration, heat may rise from the independently powered cooking zone 128 and provide heating to food items positioned on the removable roaster rack 160.

In some embodiments, the food preparation unit 110 may comprise one or more additional and/or optional features or components, including for example, an electric blender motor port 162 and corresponding blender control 164. The electric blender motor port 162 is configured and disposed to receive a blender pitcher. For example, in addition to heating and cooking food, the food preparation unit 110 may be further configured to prepare food in additional, non-heating ways. One such way is through a separate blender pitcher having blades that can be placed and coupled to the electric blender motor port 162. The blender control 164 can then be activated, whereby the electric blender motor port 162 is configured to drive the blades of the blender container, thereby blending food items contained in the blender container.

In some embodiments, the food preparation unit 110 may comprise one or more additional and/or optional features or components, including for example, a cutting board 168. The cutting board 168 may be an area located on the food preparation unit 110 configured for the cutting of meat, vegetables, or other food items. To facilitate adequate cutting, to protect cutlery, and/or to prevent cross contamination, some embodiments of the cutting board 168 may be manufactured or constructed from wood (e.g., bamboo), a synthetic material, or other material generally utilized in manufacturing cutting boards. Furthermore, the cutting board 168 may incorporate one or more waste trays, whereby a user may scrape food wastes or other undesirable items from the cutting board 168 into for disposal.

In some embodiments, the food preparation unit 110 may comprise one or more additional and/or optional features or components, including for example, at least one cup holder 170. The at least one cup holder 170 may be incorporated into or removably coupled to the food preparation unit 110 for the receiving and retaining of a drinking vessel. For example, a location on the surface of the food preparation unit 110 may comprise a circular recess that a drinking cup may be placed onto. By way of another example, a removable piece of material may be coupled to the structure of the food preparation unit 110 that may be configured for (e.g., shaped for) receiving and retaining a drinking vessel.

In some embodiments, the food preparation unit 110 may comprise one or more additional and/or optional features or components, including for example, a first temperature probe 172. The first temperature probe 172 may be an insertable gauge that can be placed into a food item that is cooking on the food preparation unit 110, thereby determining the temperature of the food item. As described in detail below with respect to FIG. 6, the first temperature probe 172 may be communicatively coupled to a processor 602 of the food preparation unit 110, whereby the temperature information obtained by the first temperature probe 172 can be provided as an output to an end user. In some embodiments, the food preparation unit 110 may comprise a plurality of temperature probes, such as the first temperature probe 172 and a second temperature probe 174.

Referring to FIGS. 4A-4B, partial, top and side views of the induction cooking zone of the induction cooktop unit 124 are depicted. As described above, the induction cooking zone may include at least one independently powered cooking zone 128 and two shared-power cooking zones 130a, 130b. The removable griddle plate 176 is an optional and/or additional attachment or cooking feature that may be utilized with the induction cooking zone. For example, the removable griddle plate 176 may be utilized to provide a grilling effect when cooking food on the induction cooking zone. In some embodiments, the removable griddle plate 176 is configured to reside at least above the two shared-power cooking zones 130a, 130b. As such, heat from each of the shared-power cooking zones 130a, 130b may be used to more evenly (e.g., more uniformly) heat the removable griddle plate 176.

In some embodiments, the removable griddle plate 176 has raised rib portions 178 extending vertically from a surface of the removable griddle plate 176. The rib portions 178 are disposed to produce grill marks and to facilitate the movement of drippings during grilling. Furthermore, the removable griddle plate 176 may be slanted to direct drippings to a drip tray 180. The drip tray 180 may be a separate element located on the food preparation unit or integrated into the removable griddle plate 176. The removable griddle plate 176 may tilt at some predefined angle, such as twenty-two degrees, or it may be adjustable to any desired angle to facilitate the movement of drippings (e.g., grease) towards the drip tray 180.

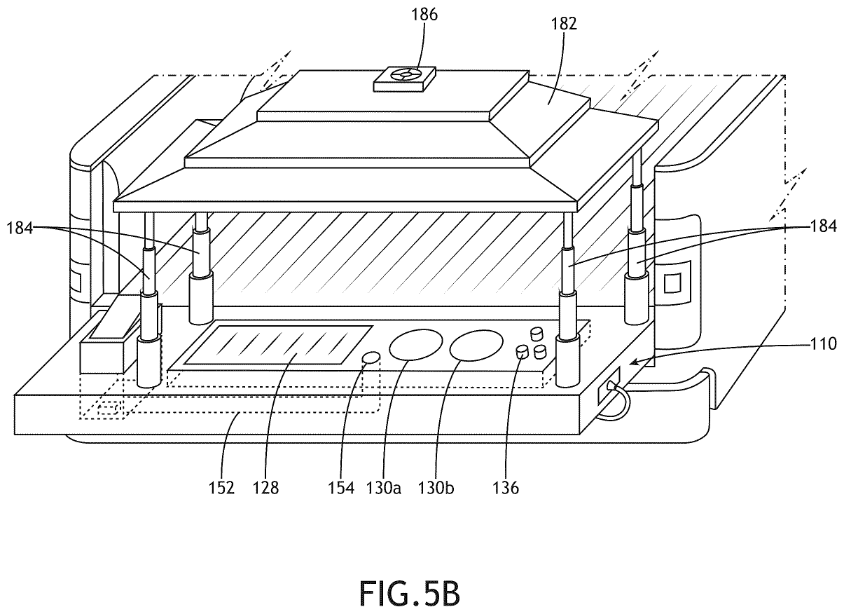

Referring now to FIGS. 5A and 5B, environmental views of the tailgate 104 and a collapsible silicone lid 182 is depicted. In some embodiments, the collapsible silicone lid 182 is an additional and/or optional cover that may be utilized by an end user. As generally depicted in the figures, the collapsible silicone lid is configured to be expanded vertically in height from a stowed position (as depicted in FIG. 5A) to an expanded position (as depicted in FIG. 5B). In some embodiments, the collapsible silicone lid 182 protects the food preparation unit 110 from environmental contamination.

In some embodiments, when the collapsible silicone lid 182 is in the stowed position (as in FIG. 5A) the lid 112 is positionable in the lid closed position. Accordingly, in some embodiments utilizing a collapsible silicone lid 182, the lid 112 may comprise dimensions or a geometric design configured for placement over the collapsible silicone lid 182 when the collapsible silicone lid 182 is in the stowed position.

In the expanded or deployed configuration (as in FIG. 5B), the silicone lid 182 may be supported by one or more silicone supports 184 that may be collapsible (e.g., telescopic) or removable. When deployed, the silicone lid 182 is sufficiently spaced away from the food preparation unit 110, such that the food preparation unit 110 (including for example the induction cooktop unit 124) is usable, unencumbered, and/or accessible to a user for cooking or other food preparation. For example, the collapsible silicone lid 182 may expand from 8 inches to 30 inches in height, however, the height of expansion may be selected from varying sizes.

In some embodiments, the silicone lid 182 optionally and/or additionally comprises at least one fan 186 supported within the dimensions of the silicone lid 182. For example, the silicone lid 182 may comprise a terraced or tiered design, with the at least one fan 186 being positioned under a top-most terrace or tier. The at least one fan 186 may be communicatively coupled to a power source (e.g., the power source of the vehicle 100) so that when the at least one fan 186 is powered, the fan 186 causes an air flow. The air flow generated by the at least one fan 186 may be used to remove fumes and/or smoke from the cooking area proximate to the food preparation unit 110.

Turning now to FIG. 6, a block diagram depicting a system 600 including the food preparation unit 110 and a remote computing device 612 according to some embodiments is depicted. In some embodiments, the food preparation unit 110 and the remote computing device 612 may be communicatively coupled at any given time. In some embodiments, the food preparation unit 110 includes at least one processor 602, at least one memory 604, at least one antenna 606, powered components 608, at least one user interface 610, and at least one temperature probe (e.g., temperature probe 172 and/or temperature probe 174), some or all of which may be communicatively coupled at any given time. In some embodiments, the remote computing device 612 includes at least one device processor 614, at least one device memory 620, at least one device antenna 618, and/or at least one device user interface 622, some or all of which may be communicatively coupled at any given time.

In some embodiments, the at least one processor 602 may include any processor or processing element known in the art. For the purposes of the present disclosure, the term “processor” or “processing element” may be broadly defined to encompass any device having one or more processing or logic elements (e.g., one or more microprocessor devices, one or more application specific integrated circuit (ASIC) devices, one or more field programmable gate arrays (FPGAs), or one or more digital signal processors (DSPs)). In this sense, the one or more processors 602 may include any device configured to execute algorithms and/or instructions (e.g., program instructions stored in memory). In one embodiment, the one or more processors 602 may be embodied as a desktop computer, mainframe computer system, workstation, image computer, parallel processor, networked computer, or any other computer system housed in the tailgate 104 and configured to execute a program configured to operate or operate in conjunction with components of the system 600, as described throughout the present disclosure.

In some embodiments, the memory 604 may include any storage medium known in the art suitable for storing program instructions executable by the associated respective one or more processors 602. For example, the memory 604 may include a non-transitory memory medium. By way of another example, the memory 604 may include, but is not limited to, a read-only memory (ROM), a random-access memory (RAM), a magnetic or optical memory device (e.g., disk), a magnetic tape, a solid-state drive and the like. It is further noted that the memory 604 may be housed in a common housing with the one or more processors 602. In one embodiment, the memory 604 may be located remotely with respect to the physical location of the respective one or more processors 602. For instance, the respective one or more processors 602 may access a remote memory (e.g., server), accessible through a network (e.g., internet, intranet, and the like).

In some embodiments, the at least one antenna 606 is a wireless communicator that is configured to wirelessly transmit and receive signals. The at least one antenna 606, for example, may wirelessly exchange signals using WiFi, Bluetooth®, cellular data, or other wireless transmission methods. As described below, the at least one antenna 606 may be in wireless communication with the remote computing device 612, allowing for the exchange of signals and information between the remote computing device 612 and the food preparation unit 110.

In some embodiments, the powered components 608 may include any of the powered aspects or parts discussed above with respect to the food preparation unit 110. For example, the powered components 608 may include the induction cooktop unit 124 (including any or all incorporated induction elements associated with the induction cooktop unit 124), the electric blender motor port, the at least one fan 186, the first temperature probe 172, the second temperature probe 174, and other components described above that are configured for receiving power. In some embodiments, the at least one processor 602 can selectively control or direct electricity to the various powered components 608 responsive to an input received by a user. The at least one processor 602 can further selectively end or block the flow of electricity to the various powered components 608 responsive to an input received by the user. For example, upon an instruction inputted by a user to power on the independently powered cooking zone 128, the at least one processor 602 can activate a switch or otherwise allow for the activation of the one or more independent cooking zone elements 132 via transfer of electricity from the at least one power source.

In some embodiments, the at least one power source is utilized in providing electricity to one or more aspects of the tailgate 104, including for example, providing electricity for heating the induction elements or activating the blender motor. The at least one power source may be for example, the battery or electrical system of vehicle 100. For example, the Dodge Ram 1500 Revolution has a 168 kWh or 229 kWh battery, the Ford Lightning F-150 has a 100 kWh battery, the Hummer EV has a 350 kWh battery. Furthermore, the Chevy Silverado, Suburban, Tahoe, and Trailblazer all contain an onboard PowerBase Charging System, which has ten outlets capable of delivering 10.2 kW of AC power (42 Amps at 240 Volts), which is sufficient to power some or all embodiments of the present disclosure. In some embodiments, the at least one power source may be an external battery or source of electricity, such as a portable or fixed generator. For example, the at least one power source may provide AC or DC power to the food preparation unit 110.

In some embodiments, the remote computing device 612 may be physically separate from, but wirelessly connected, to the food preparation unit 110. For example, the remote computing device 612 may be a smartphone, tablet, smartwatch, or other piece of computing hardware. The remote computing device 612 includes at least one device processor 614 and at least one device antenna 618. In some embodiments, the food preparation unit 110 and the remote computing device 612 are communicatively coupled through a connection (e.g., a wireless connection), which may be facilitated between the at least one antenna 606 and the at least one device antenna 618. Through such a connection, at least one instruction may be received by the food preparation unit 110 from the remote computing device 612 via the connection between the at least one antenna 606 and the at least one device antenna 618, and/or vice versa. For example, through the remote computing device 612, an end user may control at least one of the at least one induction cooking zone. Such control may be facilitated for example, through an application or web browser running on the remote computing device 612. Furthermore, a user may provide one or more inputs via the device user interface 622 of the remote computing device 612, including for example, entering inputs through an integrated keyboard or touchscreen.

Furthermore, in some embodiments, the at least one processor 602 may be further configured to receive temperature information from at least one of the first temperature probe 172 or the second temperature probe 174. The at least one processor 602 may be further configured to output at least one notification for transmission to the remote computing device 612 via the at least one antenna 606. Furthermore, the remote computing device 612 may also be configured for displaying the at least one notification. For example, displaying such a notification may include generating an icon or graphic on a display of the remote computing device 612. For example, the at least one notification may be associated with a temperature of a food item measured by one of the first temperature probe 172 or the second temperature probe 174.

As used throughout and as would be appreciated by those skilled in the art, “at least one non-transitory computer-readable medium” may refer to as at least one non-transitory computer-readable medium (e.g., at least one computer-readable medium implemented as hardware; e.g., at least one non-transitory processor-readable medium, at least one memory (e.g., at least one nonvolatile memory, at least one volatile memory, or a combination thereof; e.g., at least one random-access memory, at least one flash memory, at least one read-only memory (ROM) (e.g., at least one electrically erasable programmable read-only memory (EEPROM)), at least one on-processor memory (e.g., at least one on-processor cache, at least one on-processor buffer, at least one on-processor flash memory, at least one on-processor EEPROM, or a combination thereof), or a combination thereof), at least one storage device (e.g., at least one hard-disk drive, at least one tape drive, at least one solid-state drive, at least one flash drive, at least one readable and/or writable disk of at least one optical drive configured to read from and/or write to the at least one readable and/or writable disk, or a combination thereof), or a combination thereof).

As used throughout, “at least one” means one or a plurality of; for example, “at least one” may comprise one, two, three, . . . , one hundred, or more. Similarly, as used throughout, “one or more” means one or a plurality of; for example, “one or more” may comprise one, two, three, . . . , one hundred, or more. Further, as used throughout, “zero or more” means zero, one, or a plurality of; for example, “zero or more” may comprise zero, one, two, three, ..., one hundred, or more.

In the present disclosure, the methods, operations, and/or functionality disclosed may be implemented as sets of instructions or software readable by a device. Further, it is understood that the specific order or hierarchy of steps in the methods, operations, and/or functionality disclosed are examples of exemplary approaches. Based upon design preferences, it is understood that the specific order or hierarchy of steps in the methods, operations, and/or functionality can be rearranged while remaining within the scope of the inventive concepts disclosed herein. The accompanying claims may present elements of the various steps in a sample order, and are not necessarily meant to be limited to the specific order or hierarchy presented.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A vehicular system, comprising:
a tailgate configured to be installed on a rear of a vehicle, the tailgate configured to rotate from a closed position at least to a deployed position, the tailgate comprising:
a rear tailgate panel located at the rear of the vehicle when the tailgate is in the closed position and at a bottom of the tailgate when the tailgate is in the deployed position;
a lid assembly comprising a lid and at least one hinge, wherein the lid is rotatably connected to the tailgate via the at least one hinge such that the lid is configured to rotate between a lid open position and a lid closed position, wherein the lid is located at a front of the tailgate when the tailgate is in a closed position and at a top of the tailgate when the tailgate is in a deployed position, wherein each of the at least one hinge is located at the front and bottom of the tailgate when the tailgate is in the closed position and at the front and the top of the tailgate when the tailgate is in the deployed position; and
a food preparation unit positioned in a cavity of the tailgate and positioned between the rear tailgate panel and the lid when the lid is in the lid closed position, wherein the food preparation unit comprises:
an induction cooktop unit having at least one induction cooking zone.

2. The system of claim 1, wherein the food preparation unit further comprises a collapsible silicone lid at least extending over the induction cooktop unit, wherein the collapsible silicone lid is configured to be expanded vertically in height from a stowed position to an expanded position, wherein when the collapsible silicone lid is in the stowed position, the lid is positionable in the lid closed position, wherein when the lid is in the lid open position and the collapsible silicone lid is in the expanded position, the induction cooktop unit is accessible to a user for cooking.

3. The system of claim 2, wherein the collapsible silicone lid has a fan positioned in a top portion of the collapsible silicone lid.

4. The system of claim 1, wherein the food preparation unit further comprises a telescoping smoker box configured to be telescopically expanded vertically in height from a smoker box stowed position to a smoker box expanded position, wherein the telescoping smoker box has at least one smoker heating element.

5. The system of claim 1, wherein the food preparation unit further comprises an electric blender motor port such that, when a blender container having blades is placed into the electric blender motor port, the electric blender motor port is configured to drive the blades of the blender container.

6. The system of claim 1, wherein the at least one induction cooking zone includes an independently powered cooking zone and two shared-power cooking zones.

7. The system of claim 1, wherein the at least one induction cooking zone includes two shared-power cooking zones, wherein the two shared-power cooking zones are bridgeable to evenly distribute available power among the two shared-power cooking zones such that the two shared-power cooking zones operate as a single induction cooking zone.

8. The system of claim 7, wherein the induction cooktop unit further comprises a removable griddle plate configured to reside at least above the two shared-power cooking zones, wherein the removable griddle plate has raised rib portions extending vertically from a surface of the removable griddle plate.

9. The system of claim 8, wherein the food preparation unit further comprises a drip tray, wherein the removable griddle plate tilts at an angle to direct grease to drip into the drip tray.

10. The system of claim 1, wherein the at least one induction cooking zone includes an independently powered cooking zone, wherein the independently powered cooking zone is configured to operate in a normal power state or a power boosted state, wherein when the independently powered cooking zone operates in the power boosted state, the independently powered cooking zone receives more power than when in the normal power state.

11. The system of claim 1, wherein the food preparation unit further comprises a first temperature probe and a second temperature probe.

12. The system of claim 11, wherein the food preparation unit further comprises at least one processor and at least one antenna, the at least one antenna configured to wirelessly transmit and receive signals to and from a remote computing device having at least one device processor and at least one device antenna, the at least one processor communicatively coupled to the at least one antenna, the induction cooktop unit, the first temperature probe, and the second temperature probe.

13. The system of claim 12, wherein the at least one processor is configured to: receive temperature information from at least one of the first temperature probe or the second temperature probe; output information for transmission to the remote computing device via the at least one antenna; receive at least one instruction from the remote computing device via the at least one antenna; and based at least one the at least one instruction, control at least one of the at least one induction cooking zone.

14. The system of claim 12, wherein the at least one processor is configured to: receive temperature information from at least one of the first temperature probe or the second temperature probe; and output at least one notification for transmission to the remote computing device via the at least one antenna, wherein each of the at least one notification is associated with a temperature of a food item measured by one of the first temperature probe or the second temperature probe.

15. The system of claim 1, wherein the food preparation unit further comprises an electrical adaptor port configured to receive electricity from a power cord, wherein the electrical adaptor port includes at least one magnet, wherein the electrical adaptor port is configured to magnetically engage with the power cord.

16. The system of claim 1, wherein the lid comprises a bed liner material and a support structure, wherein the bed liner material is located at a front exterior of the tailgate when the tailgate is in the closed position and at a top exterior of the tailgate when the tailgate is in the deployed position.

17. The system of claim 16, wherein the support structure comprises support rods.

18. The system of claim 1, further comprising at least one gas strut configured to extend between the tailgate and the lid when the lid is in the lid open position, the at least one gas strut configured to support the lid when the lid is in the lid open position.

19. The system of claim 1, wherein the food preparation unit further comprises a removable roaster rack positionable over the induction cooktop unit.

20. The system of claim 1, wherein the food preparation unit further comprises a cutting board.

21. The system of claim 1, wherein the food preparation unit further comprises at least one cup holder.
